(19) United States
(12) Patent Application Publication
(10) Pub. No.: US 2015/0070714 A1
(43) Pub. Date: Mar. 12, 2015

(54) IMAGE FORMING DEVICE, PRINTING METHOD, AND COMPUTER-READABLE RECORDING MEDIUM

(71) Applicants: Tamon SADASUE, Kanagawa (JP); Kenichi OZAWA, Kanagawa (JP); Yasuhiro KAJIWARA, Kanagawa (JP); Takayuki SAITOH, Kanagawa (JP)

(72) Inventors: Tamon SADASUE, Kanagawa (JP); Kenichi OZAWA, Kanagawa (JP); Yasuhiro KAJIWARA, Kanagawa (JP); Takayuki SAITOH, Kanagawa (JP)

(21) Appl. No.: 14/471,547

(22) Filed: Aug. 28, 2014

(30) Foreign Application Priority Data
Sep. 11, 2013 (JP) 2013-188870

(51) Int. Cl. G06K 15/02; G06K 9/00; G06T 19/00

(52) U.S. Cl. CPC G06K 15/1843; G06T 19/006; G06K 9/00671
USPC 358/1.2

(57) ABSTRACT

An image forming device includes: an image acquisition unit that acquires an image including a marker used for an augmented reality process; an information acquisition unit that acquires first information which is embedded in the marker from the marker and is related to a size of the marker in a real world before the image is printed; a calculation unit that calculates, on the basis of the first information and a printing magnification of the image, the size of the marker in the real world after the image is printed; a replacement unit that replaces the first information embedded in the marker with second information related to the calculated size; and a printing unit that prints, at the printing magnification, the image including the marker in which the second information is embedded.

### CROSS-REFERENCE TO RELATED APPLICATIONS

The present application claims priority to and incorporates by reference the entire contents of Japanese Patent Application No. 2013-188870 filed in Japan on Sep. 11, 2013.

### BACKGROUND OF THE INVENTION

1. Field of the Invention

The present invention relates to an image forming device, a printing method, and a computer-readable recording medium.

2. Description of the Related Art

Conventionally, a technique called augmented reality (AR) is known which augments a real environment by superimposing information such as a virtual object on an image in a real world perceived by a user and displaying the image (for example, see Japanese Patent Application Laid-open No. 2009-020614).

For example, there is a method in which an image of a printed matter on which an AR marker in which information indicating the size of the AR marker is embedded is printed is captured by a camera, a relative position and attitude of the camera is detected by analyzing the captured image, the information embedded in the AR marker is acquired from the captured image, and a virtual object based on the AR marker is added to an image on the basis of the detected relative position and attitude of the camera and the acquired information.

However, in the conventional technique as described above, when the printed matter on which the AR marker is printed is variably magnified and printed, the size of the AR marker after the printing is different from the size of the AR marker based on the information embedded in the AR marker. Therefore, when implementing the augmented reality, it is not possible to display the virtual object based on the AR marker at the size according to the real world.

In view of the above situation, there is a need to provide an image forming device, a printing method, and a computer-readable recording medium having a computer program, which can make the size of the AR marker after the printing correspond to the size of the AR marker based on the information embedded in the AR marker even when the printed matter on which the AR marker is printed is variably magnified and printed.

### SUMMARY OF THE INVENTION

It is an object of the present invention to at least partially solve the problems in the conventional technology.

According to the present invention, there is provided an image forming device comprising: an image acquisition unit that acquires an image including a marker used for an augmented reality process; an information acquisition unit that acquires first information which is embedded in the marker from the marker and is related to a size of the marker in a real world before the image is printed; a calculation unit that calculates, on the basis of the first information and a printing magnification of the image, the size of the marker in the real world after the image is printed; a replacement unit that replaces the first information embedded in the marker with second information related to the calculated size; and a printing unit that prints, at the printing magnification, the image including the marker in which the second information is embedded.

The present invention also provides a printing method comprising: an image acquisition step of acquiring an image including a marker used for an augmented reality process; an information acquisition step of acquiring from the marker first information which is embedded in the marker and is related to a size of the marker in a real world before the image is printed; a calculation step of calculating, on the basis of the first information and a printing magnification of the image, the size of the marker in the real world after the image is printed; a replacement step of replacing the first information embedded in the marker with second information related to the calculated size; and a printing step of printing, at the printing magnification, the image including the marker in which the second information is embedded.

The present invention also provides a non-transitory computer-readable recording medium that contains a computer program that causes a computer to execute: an image acquisition step of acquiring an image including a marker used for an augmented reality process; an information acquisition step of acquiring from the marker first information which is embedded in the marker and is related to a size of the marker in a real world before the image is printed; a calculation step of calculating, on the basis of the first information and a printing magnification of the image, the size of the marker in the real world after the image is printed; a replacement step of replacing the first information embedded in the marker with second information related to the calculated size; and a printing step of printing, at the printing magnification, the image including the marker in which the second information is embedded.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of an image forming device of an embodiment of the present invention;

FIG. 2 is a diagram illustrating an example of an AR marker of the present embodiment;

FIG. 3 is a flowchart illustrating an example of a printing process performed by the image forming device of the present embodiment;

FIG. 4 is a configuration diagram illustrating an example of an AR processing system that performs an augmented reality process by using a printed matter including an AR marker printed by the image forming device of the present embodiment;

FIG. 5 is a flowchart illustrating an example of the augmented reality process performed by an AR processing terminal;

FIG. 6 is an illustration of an example of the augmented reality process;

FIG. 7 is an illustration of an example of the augmented reality process;

FIG. 8 is an illustration of an example of the augmented reality process;

FIG. 9 is a block diagram illustrating an example of a configuration of an image forming device of a modified example;

FIG. 10 is a diagram illustrating an example of an AR marker of the modified example;

FIG. 11 is a diagram illustrating an example of a table managed by a server;

FIG. 12 is a diagram illustrating an example of a table managed by the server; and

FIG. 13 is a block diagram illustrating an example of a hardware configuration of the image forming device of the embodiment and the modified example.

### DETAILED DESCRIPTION OF THE PREFERRED EMBODIMENT

Hereinafter, an embodiment of an image forming device, a printing method, and a computer-readable recording medium having a computer program according to the present invention will be described in detail with reference to the attached drawings. The description below is based on the assumption that the image forming device is a copying machine. However, the image forming device is not limited to a copying machine, but may be a printer, a multifunction peripheral (MFP), and the like. The multifunction peripheral is a peripheral that has at least two functions of a copy function, a printing function, a scanner function, and a facsimile function.

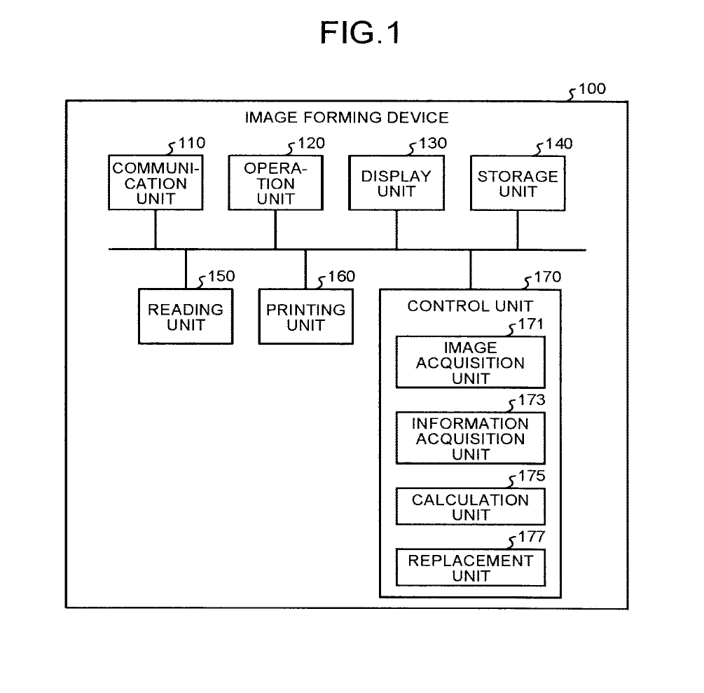

FIG. 1 is a block diagram illustrating an example of a configuration of an image forming device 100 of the present embodiment. As illustrated in FIG. 1, the image forming device 100 includes a communication unit 110, an operation unit 120, a display unit 130, a storage unit 140, a reading unit 150 (an example of a reading device), a printing unit 160, and a control unit 170.

The communication unit 110 communicates with an external device such as a PC (Personal Computer) through a network and can be realized by a communication device such as an NIC (Network Interface Card).

The operation unit 120 is for inputting various operations such as inputting a printing magnification (magnification rate) and can be realized by an input device such as a touch panel and key switches.

The display unit 130 is for displaying various screens and can be realized by a display device such as a liquid crystal display and a touch panel type display.

The storage unit 140 stores various programs executed by the image forming device 100 and data used for various processes performed by the image forming device 100. The storage unit 140 can be realized by at least any one of storage devices, which can magnetically, optically, electrically store information, such as, for example, an HDD (Hard Disk Drive), an SSD (Solid State Drive), a memory card, an optical disk, and a RAM (Random Access Memory).

The reading unit 150 is for optically reading a document and generating an image following an instruction of the control unit 170, and can be realized by, for example, a scanner device.

Following an instruction of the control unit 170, the printing unit 160 prints an image, which is read by the reading unit 150 and processed by the control unit 170, on a recording medium such as a recording paper, and outputs the recording medium.

The control unit 170 is for controlling each unit of the image forming device 100 and can be realized by a CPU (Central Processing Unit), an LSI (Large Scale Integration), or the like. The control unit 170 includes an image acquisition unit 171, an information acquisition unit 173, a calculation unit 175, and a replacement unit 177.

The image acquisition unit 171 acquires an image including a marker (hereinafter referred to as an “AR marker”) used for an augmented reality process. In the present embodiment, the image acquisition unit 171 optically reads a document on which the AR marker is printed and generates an image including the AR marker, so that the image acquisition unit 171 acquires the image. However, the image acquisition unit 171 may acquire the image including the AR marker from the outside (for example, a PC (an example of an information processing device) connected through a network).

The information acquisition unit 173 acquires first information which is related to the size of the AR marker in the real world before the image is printed and which is embedded in the AR marker from the AR marker in the image acquired by the image acquisition unit 171. Specifically, the information acquisition unit 173 detects the AR marker from the image acquired by the image acquisition unit 171 and acquires the first information embedded in the detected AR marker.

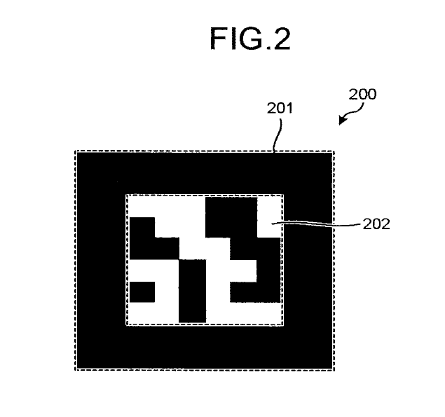

FIG. 2 is a diagram illustrating an example of an AR marker 200 of the present embodiment. The AR marker 200 includes an external area 201 and an internal area 202. The external area 201 is used to detect the AR marker 200 and the internal area 202 is used to embed the first information.

In the example illustrated in FIG. 2, the shape of the AR marker 200 is square. However, it is not limited to this, and the shape may be rectangle, circle, and the like as long as the shape is known and can be detected. It is preferable that the color of the AR marker 200 is monochrome from a viewpoint of image processing. However, the color is not limited to monochrome, but may be made of a plurality of colors.

For example, the information acquisition unit 173 binarizes the image acquired by the image acquisition unit 171 and divides the image into blocks of white pixels and black pixels by performing labeling processing (processing to combine pixels of the same color adjacent to each other into one block). Then, the information acquisition unit 173 performs processing to detect four vertexes from contour for each divided block of black pixels. As a result, a block of black pixels where the four vertexes are detected is the external area 201 of the AR marker 200, so that the information acquisition unit 173 can detect the AR marker 200 from the image acquired by the image acquisition unit 171 and can acquire the first information from the internal area 202 of the AR marker 200. When the shape of the AR marker 200 is a circle, the information acquisition unit 173 may detect a block of black pixels forming a circle by performing Hough transform or the like.

In the present embodiment, the first information indicates the size of the AR marker in the real world before the image is printed (copied), and in more detail, the first information indicates the size of the AR marker in the real world before the image is printed by a combination of colors of components that form a predetermined area in the AR marker. For example, in the case of the AR marker 200 illustrated in FIG. 2, the size of the AR marker in the real world before the image is printed is indicated by a combination of colors of pixels that form the internal area 202.

In the AR marker 200 illustrated in FIG. 2, the internal area 202 is formed by 6Δ6 pixels, and the size of the AR marker in the real world before the image is printed is represented by a binary number by assuming that the white pixel is 0 and the black pixel is 1. However, among the 36 bits (pixels), the values of pixels at four corners of the internal area 202 are used to detect the orientation of the image (AR marker 200) in order to be able to detect the AR marker 200 even when the image is rotated in whatever direction (up/down/left/right). Further, among the remaining 32 bits, the first eight bits are used as an identifier of a 3D virtual object based on the AR marker 200 used in the augmented reality process. Therefore, in the example illustrated in FIG. 2, the length of one side of the AR marker 200 can be represented by 24 bits (pixels), so that, when the length of one side of the AR marker 200 is described in units of 1 mm, the length of one side can be described in a range from 1 mm to 16777216 mm. However, when a checksum or the like is added to improve robustness, the description range of the length of one side of the AR marker 200 is smaller than the above range.

The calculation unit 175 calculates the size of the AR marker in the real world after the image is printed on the basis of the first information acquired by the information acquisition unit 173 and the printing magnification of the image acquired by the image acquisition unit 171.

In the present embodiment, the printing magnification is inputted from the operation unit 120, so that the calculation unit 175 uses the printing magnification to calculate the size of the AR marker in the real world after the image is printed. However, when the image acquisition unit 171 acquires the image including the AR marker from the outside, the image acquisition unit 171 may also acquire the printing magnification of the image from the outside and the calculation unit 175 may use the printing magnification.

For example, when variable magnification printing (enlarged printing) of a printing magnification of 1.4 times is instructed from the operation unit 120, the calculation unit 175 calculates the size of the AR marker in the real world after the image is printed by multiplying the size indicated by the first information by 1.4.

The replacement unit 177 replaces the first information embedded in the AR marker with second information related to the size calculated by the calculation unit 175. In the present embodiment, the second information indicates the size of the AR marker in the real world after the image is printed (copied), and in more detail, the second information indicates the size of the AR marker in the real world after the image is printed by a combination of colors of components that form a predetermined area in the AR marker.

Specifically, the replacement unit 177 replaces a combination of colors indicated by the first. information embedded in the AR marker with a combination of colors indicated by the second information. For example, the replacement unit 177 calculates the second information by converting the size calculated by the calculation unit 175 into a binary number and replaces the 24 pixels used to describe the aforementioned first information with a combination of colors indicated by bits of the second information.

However, the replacement unit 177 may not only replace the 24 pixels used to describe the first information, but also collectively replace 36 pixels in the internal area 202 of the AR marker 200 illustrated in FIG. 2 in order to easily perform the replacement process. In this case, the value of the 24 pixels used to describe the first information is different between before and after the replacement because the value is replaced with the second information. However, the values of the other 12 pixels (four pixels for detecting the orientation of the image (AR marker 200) and eight pixels for an identifier of the 3D virtual object based on the AR marker 200) are the same.

The replacement unit 177 replaces the first information with second information, so that the printing unit 160 prints the image including the AR marker in which the second information is embedded at the printing magnification inputted from the operation unit 120 and outputs a printed matter. Specifically, by the control unit 170, the printing unit 160 converts the image, which includes the AR marker in which the second information is embedded and which is variably magnified at the printing magnification inputted from the operation unit 120, from the RGB color space to the CMYK color space and performs printing.

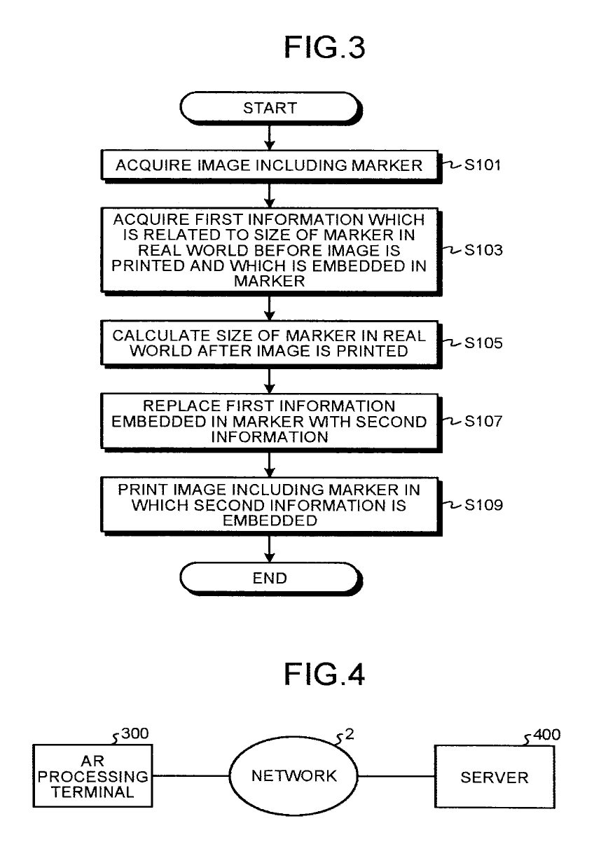

FIG. 3 is a flowchart illustrating an example of a printing process performed by the image forming device 100 of the present embodiment.

First, the image acquisition unit 171 acquires an image including an AR marker used for the augmented reality process (step S101).

Subsequently, the information acquisition unit 173 acquires, the first information which is related to the size of the AR marker in the real world before the image is printed and which is embedded in the AR marker, from the AR marker in the image acquired by the image acquisition unit 171 (step S103).

Subsequently, the calculation unit 175 calculates the size of the AR marker in the real world after the image is printed on the basis of the first information acquired by the information acquisition unit 173 and the printing magnification of the image acquired by the image acquisition unit 171 (step S105).

Subsequently, the replacement unit 177 replaces the first information embedded in the AR marker with second information related to the size calculated by the calculation unit 175 (step S107).

Subsequently, the printing unit 160 prints, the image including the AR marker in which the second information is embedded by the replacement unit 177, with the printing magnification inputted from the operation unit 120, and the printing unit 160 outputs a printed matter (step S109).

As described above, according to the present embodiment, the AR marker is printed after replacing the first information related to the size of the AR marker embedded in the AR marker with the second information related to the size of the AR marker after the AR marker is printed which is calculated based on the first information and the printing magnification, so that it is possible to make the size of the AR marker after the AR marker is printed correspond to the size of the AR marker based on the information embedded in the AR marker. As a result, when a printed matter on which the AR marker is printed (copied) is variably magnified and printed, it is possible to make the size of the AR marker after the printing correspond to the size of the AR marker based on the information embedded in the AR marker, so that when implementing the augmented reality, it is possible to display the virtual object based on the AR marker at the size according to the real world.

FIG. 4 is a configuration diagram illustrating an example of an AR processing system that performs the augmented reality process by using a printed matter including the AR marker printed by the image forming device 100 of the present embodiment. As illustrated in FIG. 4, the AR processing system includes an AR processing terminal 300 and a server 400. The AR processing terminal 300 and the server 400 are connected through a network 2.

The AR processing terminal 300 is a terminal device including a camera, a GPU (Graphics Processing Unit), and a display. Examples of the AR processing terminal 300 include a smartphone and a tablet terminal. The server 400 manages a 3D virtual object or the like based on the AR marker.

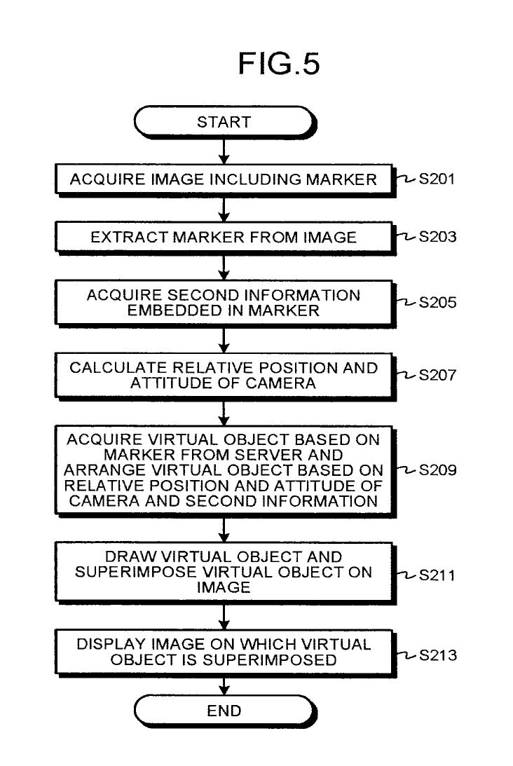

FIG. 5 is a flowchart illustrating an example of the augmented reality process performed by the AR processing terminal 300. The augmented reality process illustrated in FIG. 5 is performed for each frame.

First, the AR processing terminal 300 captures an image of a printer matter including a marker printed by the image forming device 100 and acquires the image (step S201).

Subsequently, the AR processing terminal 300 extracts the AR marker from the acquired image (step S203). The method of extracting the AR marker is the same as that described in the description of the information acquisition unit 173.

Subsequently, the AR processing terminal 300 acquires, from the extracted marker, the second information embedded in the AR marker and an identifier of a 3D virtual object based on the AR marker (step S205).

Subsequently, the AR processing terminal 300 calculates (estimates) a relative position and attitude of the camera by using coordinates of four vertexes detected in step S203 (for details, see the method described in the description of the information acquisition unit 173) (step S207). Specifically, the AR processing terminal 300 calculates the relative position and attitude of the camera by obtaining a conversion from the coordinates of four vertexes arranged in a square in a three-dimensional marker coordinate system to a two-dimensional camera virtual screen coordinate system. Regarding a method of detecting the relative position and attitude between the AR marker and the camera, “ARToolkit: Library for Vision-based Augmented Reality” Technical report of IEICE. pp 79-86, 2002-02 is known. The AR marker coordinate system is often a global coordinate system for finally arranging a virtual object.

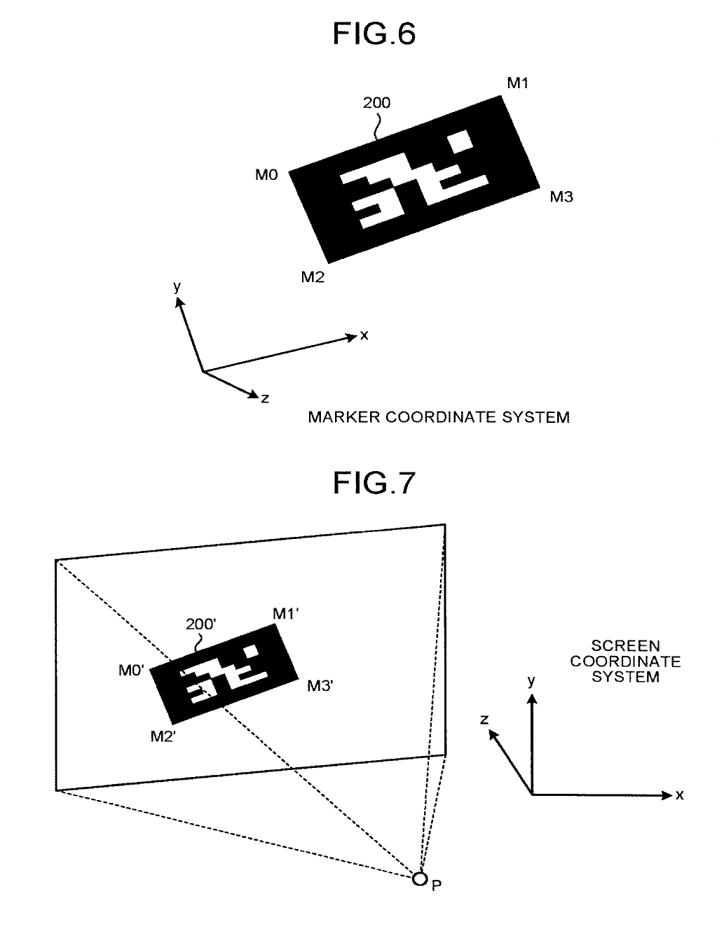

Here, it is known that the four vertexes are on the same plane, so that in the three-dimensional coordinate system, when the center of the AR marker 200 is (x, y, z)=(0, 0, 0), the coordinates of four vertexes M0 to M3 are represented as M0=(−a, −a, 0), M1=(a, −a, 0), M2=(−a, a, 0), and M2=(a, a, 0) (see FIG. 6).

When a three dimensional coordinate conversion including desired rotation and parallel movement is performed on these coordinates, the coordinates of the four vertexes M0 to M4 are converted into coordinates in a three-dimensional camera coordinate system. Then, by performing a perspective projection from the three-dimensional camera coordinate system to a virtual screen, two-dimensional coordinate values M0′ to M3′ are obtained (see FIG. 7). Parameters of the rotation and parallel movement at this time correspond to the relative position and attitude of the camera.

Subsequently, the AR processing terminal 300 acquires a 3D virtual object from the server 400 based on the identifier of the 3D virtual object being based on the AR marker embedded in the AR marker, and arranges the 3D virtual object in a three-dimensional space of the AR marker coordinate system based on the relative position and attitude of the camera and the second information (step S209). Here, the second information is used to arrange the 3D virtual object, so that it is possible to arrange the 3D virtual object at the size according to the real world.

Subsequently, the AR processing terminal 300 draws an image formed when perspectively projecting the 3D virtual object arranged in the three-dimensional space onto a screen, and superimposes the drawn image on the image acquired in step S201 (step S211). For example, the AR processing terminal 300 draws the 3D virtual object arranged in the three-dimensional space on the image acquired in step S201 by using a 3D programming API such as OpenGL and Direct3D.

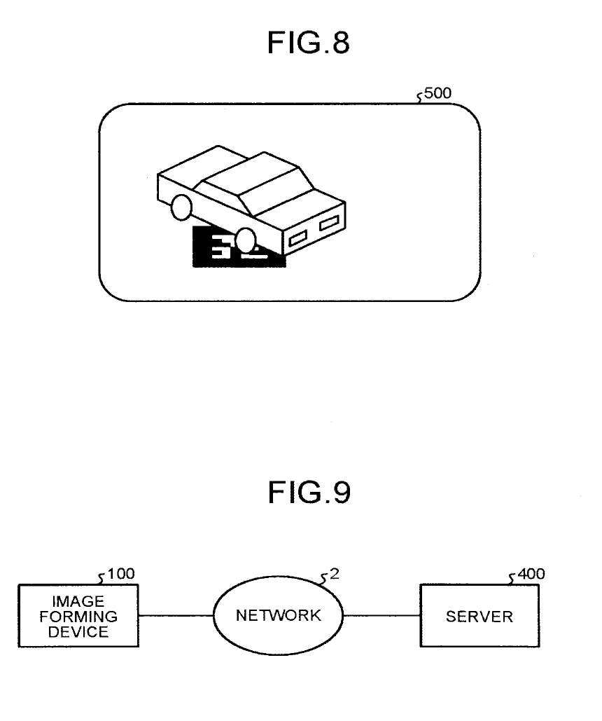

Subsequently, the AR processing terminal 300 displays the image on which the virtual object is superimposed (see FIG. 8) on a display 500 (step S213).

In this way, when a printed matter on which the AR marker is printed (copied) is variably magnified and printed, it is possible to make the size of the AR marker after the printing correspond to the size of the AR marker based on the information embedded in the AR marker, so that when implementing the augmented reality, it is possible to display the virtual object based on the AR marker at the size according to the real world.

### Modified Example

The present invention is not limited to the above embodiment, but various modifications can be made. For example, the first information may be information associated with first size information indicating the size of the AR marker in the real world before the image is printed, and the second information may be information associated with second size information indicating the size of the AR marker in the real world after the image is printed.

FIG. 9 is a block diagram illustrating an example of a configuration of an image forming device 100 of a modified example. As illustrated in FIG. 9, the image forming device 100 is connected to a server 400 through a network 2. The server 400 manages the first information and the first size information in association with each other, and manages the second information and the second size information in association with each other.

In the image forming device 100 of the modified example, the calculation unit 175 acquires the first size information from the server 400 on the basis of the first information, and calculates the size of the AR marker in the real world after the image is printed on the basis of the first size information and the printing magnification. The replacement unit 177 acquires the second information from the server 400 on the basis of the second size information indicating a calculated size, and replaces the first information embedded in the AR marker with the second information.

In the same manner as in the above embodiment, the first information and the second information may indicate a combination of colors of components that form a predetermined area in the AR marker. In this case, the combination of colors of components is a mere identifier.

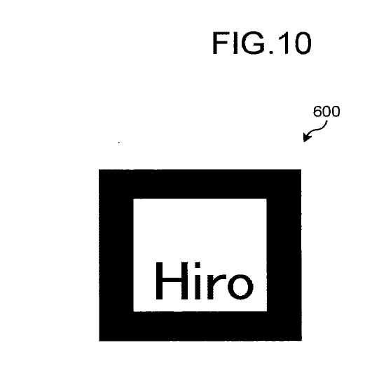

The first information and the second information may indicate a first pattern and a second pattern, respectively. In this case, the first pattern and the second pattern are mere identifiers. FIG. 10 is a diagram illustrating an example of an AR marker 600 of the modified example. In the case of the AR marker 600 illustrated in FIG. 10, the first information is acquired by performing pattern matching on an internal area of the AR marker 600. The replacement unit 177 replaces the first. pattern indicated by the first information with the second pattern indicated by the second information. The replacement method is the same as described above.

When the second information is not registered in the server 400, the replacement unit 177 generates the second information and registers, in the server 400, the second information and the second size information in association with each other.

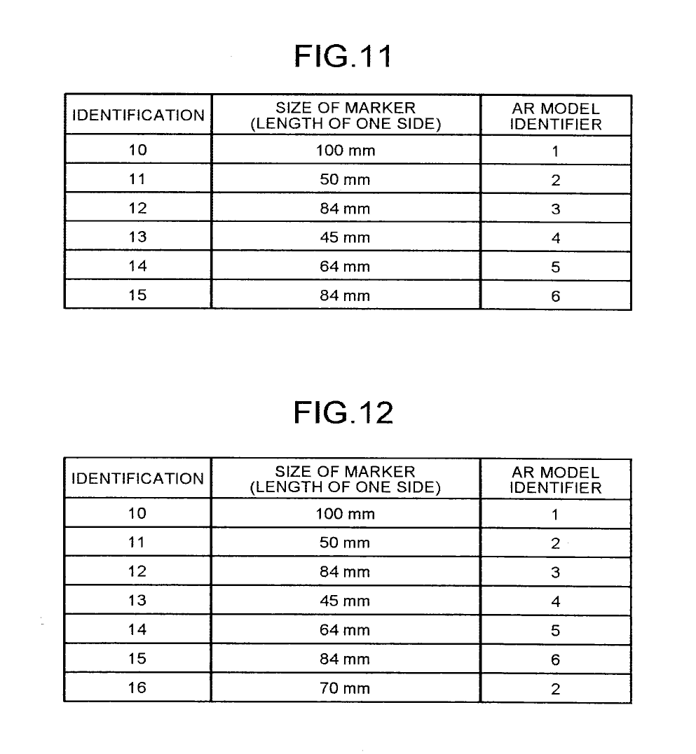

For example, the server 400 manages the first information and the first size information in association with each other, and manages the second information and the second size information in association with each other in a table illustrated in FIG. 11. Here, the “identification” corresponds to the first information and the second information, and the “size of marker” corresponds to the first size information and the second size information. The calculation unit 175 calculates the size of the AR marker in the real world after the image is printed to be 70 mm.

In this case, the size of marker of 70 mm is not registered in the table illustrated in FIG. 11, so that, as illustrated in FIG. 12, the replacement unit 177 generates the second information (16), and registers the second information (16) and the second size information indicating 70 mm in association with each other. Further, the replacement unit 177 may register an identifier of a 3D virtual object based on the AR marker 200 (AR model identifier).

### Hardware Configuration

An example of a hardware configuration of the image forming device of the embodiment and the modified example will be described.

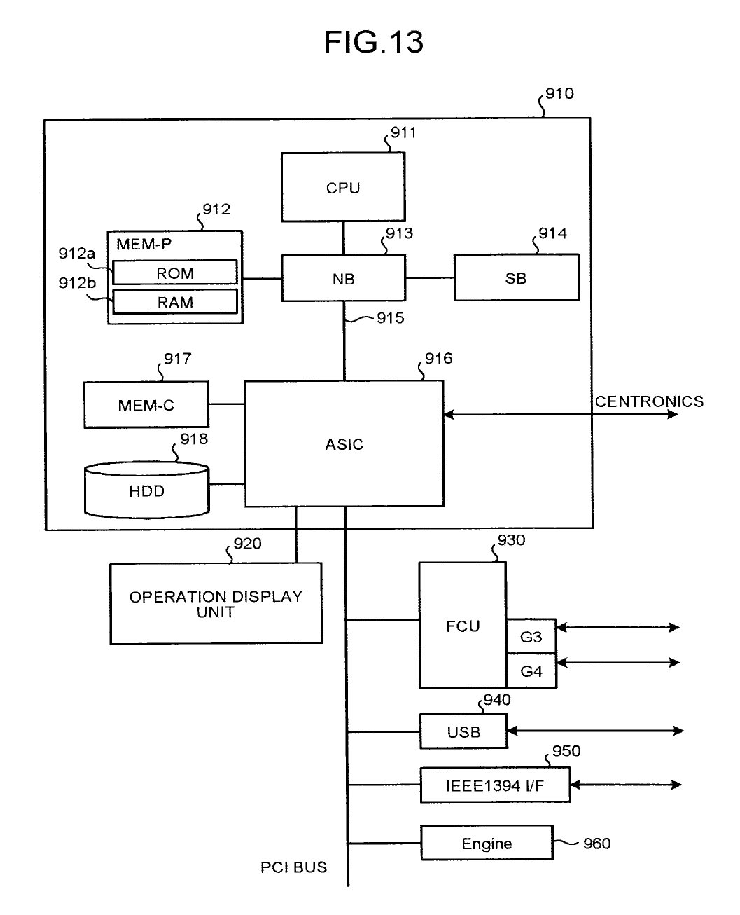

FIG. 13 is a block diagram illustrating an example of the hardware configuration of the image forming device 100 of the embodiment and the modified example. As illustrated in FIG. 13, the image forming device of the embodiment. and the modified example has a configuration in which a controller 910 and an engine 960 are connected by a PCI (Peripheral Component Interconnect) bus. The controller 910 is a controller that controls control of the entire image forming device, drawing, communication, and input from an operation display unit 920. The engine 960 is a printer engine that can be connected to the PCI bus. The engine 960 is, for example, a monochrome plotter, one-drum color plotter, four-drum color plotter, a scanner, or a fax unit. The engine 960 includes an image processing section for error diffusion and gamma conversion in addition to a so-called engine section such as a plotter.

The controller 910 includes a CPU 911, a northbridge (NB) 913, a system memory (MEN-P) 912, a southbridge (SB) 914, a local memory (MEM-C) 917, an ASIC (Application Specific Integrated Circuit) 916, and a hard disk drive (HDD) 918. The northbridge (NB) 913 and the ASIC 916 are connected by an AGP (Accelerated Graphics Port) bus 915. The MEM-P 912 includes a ROM 912a and a RAM 912b.

The CPU 911 controls the entire image forming device and has a chip set including the NB 913, the MEN-P 912, and the SB 914. The CPU 911 is connected to other devices through the chip set.

The NB 913 is a bridge for connecting the CPU 911, the MEM-P 912, the SB 914, and the AGB bus 915 and has a memory controller that controls reading and writing from and to the MEM-P 912, a PCI master, and an AGP target.

The MEM-P 912 is a system memory used as a storage memory for storing programs and data, a developing memory for developing programs and data, and a drawing memory for a printer. The MEM-P 912 includes the ROM 912a and the RAM 912b. The ROM 912a is a read-only memory used as the storage memory for storing programs and data. The RAM 912b is a readable/writable memory used as the developing memory for developing programs and data and the drawing memory for a printer.

The SB 914 is a bridge for connecting the NB 913, PCI devices, and peripheral devices. The SB 914 is connected to the NB 913 through the PCI bus and the PCI bus is connected with a network interface (I/F) unit.

The ASIC 916 is an image processing IC (Integrated Circuit) including a hardware component for image processing and plays a role of a bridge for connecting the AGP bus 915, the PCI bus, the HDD 918, and the MEM-C 917. The ASIC 916 includes a PCI target, an AGP master, an arbiter (ARB) that is the core of the ASIC 916, a memory controller that controls the MEN-C 917, a plurality of DMACs (Direct Memory Access Controllers) that perform rotation of image data and the like by a hardware logic or the like, and a PCI unit that performs data transfer with the engine 960 through the PCI bus. The ASIC 916 is connected with an FCU (Fax Control Unit) 930, a USE (Universal Serial Bus) 940, and an IEEE1394 (the Institute of Electrical and Electronics Engineers 1394) interface 950 through the PCI bus. The operation display unit 920 is directly connected to the ASIC 916.

The MEM-C 917 is a local memory used as an image buffer for copy and a code buffer. The HDD 918 is a storage for accumulating image data, accumulating programs, accumulating font data, and accumulating forms.

The AGP bus 915 is a bus interface for a graphics accelerator card proposed to accelerate graphics processing. The AGP bus 915 increases the speed of the graphics accelerator card by directly accessing the MEM-P 912 with high throughput.

The programs executed by the image forming device of the embodiment and the modified example are installed in a ROM or the like in advance and provided.

The programs executed by the image forming device of the embodiment. and the modified example may be recorded in a non-transitory computer-readable recording medium such as a CD-ROM, a flexible disk (FD), a CD-R, and a DVD (Digital Versatile Disk) as a file of an installable format or an executable format and provided.

Further, the programs executed by the image forming device of the embodiment and the modified example may be stored in a computer connected to a network such as the Internet and provided by downloading the programs through the network. Further, the programs executed by the image forming device of the embodiment and the modified example may be provided or delivered through a network such as the Internet.

The programs executed by the image forming device of the embodiment and the modified example have a module configuration to realize each unit described above on a computer. In actual hardware, a processor reads the programs from a ROM, stores the programs in a RAM, and executes the program, so that each unit described above is realized on a computer.

According to the present invention, an effect is obtained in which, even when the printed matter on which the AR marker is printed is variably magnified and printed, it is possible to make the size of the AR marker after the printing correspond to the size of the AR marker based on the information embedded in the AR marker.

Although the invention has been described with respect specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming device comprising:
an image acquisition unit that acquires an image including a marker used for an augmented reality process;
an information acquisition unit that acquires first information which is embedded in the marker from the marker and is related to a size of the marker in a real world before the image is printed;
a calculation unit that calculates, on the basis of the first information and a printing magnification of the image, the size of the marker in the real world after the image is printed;
a replacement unit that replaces the first information embedded in the marker with second information related to the calculated size; and
a printing unit that prints, at the printing magnification, the image including the marker in which the second information is embedded.

2. The image forming device according to claim 1, wherein
the first information indicates the size of the marker in the real world before the image is printed, and
the second information indicates the size of the marker in the real world after the image is printed.

3. The image forming device according to claim 2, wherein
the first information indicates, by a combination of colors of components that form a predetermine area in the marker, the size of the marker in the real world before the image is printed,
the second information indicates, by a combination of colors of components that form the predetermine area, the size of the marker in the real world after the image is printed, and
the replacement unit replaces the combination of colors indicated by the first information with the combination of colors indicated by the second information.

4. The image forming device according to claim 1, wherein
the first information is information associated with first size information that indicates the size of the marker in the real world before the image is printed,
the second information is information associated with second size information that indicates the size of the marker in the real world after the image is printed,
the calculation unit acquires the first size information from an external device on the basis of the first information, and calculates the size of the marker in the real world after the image is printed on the basis of the first size information and the printing magnification, and
the replacement unit acquires the second information from the external device on the basis of the second size information indicating the calculated size, and replaces the first information embedded in the marker with the second information.

5. The image forming device according to claim 4, wherein
the first information indicates a first pattern associated with the first size information,
the second information indicates a second pattern associated with the second size information,
the information acquisition unit acquires the first information by performing pattern matching on the marker, and
the replacement unit replaces the first pattern indicated by the first information with the second pattern indicated by the second information.

6. The image forming device according to claim 4, wherein
the first information indicates a combination of colors of components that form a predetermine area in the marker, the combination being associated with the first size information,
the second information indicates a combination of colors of components that form the predetermine area, the combination being associated with the second size information, and
the replacement unit replaces the combination of colors indicated by the first information with the combination of colors indicated by the second information.

7. The image forming device according to claim 4, wherein
when the second information is not registered in the external device, the replacement unit generates the second information, and registers in the external device the second information and the second size information in association with each other.

8. The image forming device according to claim 1, wherein
the image acquisition unit acquires the image from a reading device that optically reads an image or an information processing device.

9. A printing method comprising:
an image acquisition step of acquiring an image including a marker used for an augmented reality process;
an information acquisition step of acquiring from the marker first information which is embedded in the marker and is related to a size of the marker in a real world fore the image is printed;
a calculation step of calculating, on the basis of the first information and a printing magnification of the image, the size of the marker in the real world after the image is printed;
a replacement step of replacing the first information embedded in the marker with second information related to the calculated size; and
a printing step of printing, at the printing magnification, the image including the marker in which the second information is embedded.

10. A non-transitory computer-readable recording medium that contains a computer program that causes a computer to execute:
an image acquisition step of acquiring an image including a marker used for an augmented reality process;
an information acquisition step of acquiring from the marker first information which is embedded in the marker and is related to a size of the marker in a real world before the image is printed;
a calculation step of calculating, on the basis of the first information and a printing magnification of the image, the size of the marker in the real world after the image is printed;
a replacement step of replacing the first information embedded in the marker with second information related to the calculated size; and
a printing step of printing, at the printing magnification, the image including the marker in which the second information is embedded.
